(19) United States
(12) Patent Application Publication
(10) Pub. No.: US 2014/0152440 A1
(43) Pub. Date: Jun. 5, 2014

(54) ANTI-THEFT DEVICE FOR CAMERA LENS

(71) Applicant: InVue Security Products Inc., Charlotte, NC (US)

(72) Inventors: David N. Berglund, Charlotte, NC (US); Larry T. McKinney, Huntersville, NC (US); Jeffrey A. Grant, Charlotte, NC (US)

(73) Assignee: InVue Security Products Inc., Charlotte, NC (US)

(21) Appl. No.: 14/095,437

(22) Filed: Dec. 3, 2013

Related U.S. Application Data
(60) Provisional application No. 61/733,143, filed on Dec. 4, 2012.

(51) Int. Cl. G08B 13/14

(52) U.S. Cl. CPC G08B 13/1445
USPC 340/568.2; 340/568.1

(57) ABSTRACT

Embodiments of the present invention are directed to anti-theft devices, systems, and methods. For example, an anti-theft device includes a lens ring assembly comprising a ring configured to removably engage a removable camera lens. The anti-theft device also includes a sensor cable assembly configured to attach to the lens ring assembly and to provide a signal indicative of an unauthorized removal of the lens ring assembly from the removable camera lens or removal of the sensor cable assembly from the lens ring assembly.

### CROSS REFERENCE TO RELATED APPLICATIONS

This non-provisional utility patent application claims the benefit of priority of U.S. Provisional Application No. 61/733,143, filed on Dec. 4, 2012, entitled ANTI-THEFT DEVICE FOR CAMERA LENS, which is hereby incorporated by reference in its entirety.

### FIELD OF THE INVENTION

Embodiments of the present invention relate generally to anti-theft devices and, in particular, to anti-theft devices, systems, and methods for protecting a camera lens from theft in a retail display of a camera having a removable lens.

### BACKGROUND OF THE INVENTION

It is known to protect the removable camera lens of a camera on display in a retail store from theft using an auxiliary sensor. The auxiliary sensor typically comprises a sensor switch that is electrically connected to a main sensor body, commonly referred to as a “sensor head,” by a cable comprising one or more conductors that define a sense loop. The sensor switch may be an optical switch, a proximity switch (e.g. reed switch), or a biased limit switch, commonly referred to as a “plunger switch.” The cable operatively couples the sensor switch to monitoring electronics disposed within the sensor head that monitor whether the auxiliary sensor is in a secured state or an unsecured state. For example, when the auxiliary sensor is securely attached to the camera lens and the plunger switch depressed, the auxiliary sensor is in a secured state. Conversely, when the auxiliary sensor is detached from the camera lens and the plunger switch is biased to its extended position, the auxiliary sensor is in an unsecured state.

Unfortunately, the majority of camera lenses have a cylindrical outer surface that is less than ideal for securely attaching a sensor switch of an auxiliary sensor to the camera lens. As a result, conventional sensor switches are more easily detached from the camera lens by a potential shoplifter attempting to steal the camera lens and/or the camera from the display. Flexible sensor switches have been developed that conform to the contour of the exterior surface of a camera lens. However, such sensor switches are inherently fragile and generally are not as robust and reliable as a sensor switch disposed within a more rigid housing. It is also known to utilize a security strap, such as a cable tie, to secure the sensor switch to the exterior surface of the camera lens. However, the cable tie is vulnerable to tampering (e.g. cutting) and typically detracts from the aesthetic appearance of the display by introducing additional structural components to the anti-theft system.

Accordingly, what is needed is an anti-theft device for protecting a camera lens from theft in a retail display of a camera having a removable camera lens that overcomes the deficiencies of the known anti-theft devices. More particularly, an anti-theft device for a camera lens is needed that includes a sensor switch configured to be securely attached to the camera lens without introducing additional structure that detracts from the overall aesthetic appearance of a retail display of a camera having a removable camera lens.

### BRIEF SUMMARY OF THE INVENTION

Embodiments of the present invention are directed to anti-theft devices, systems, and methods for protecting a removable camera lens from theft. In one embodiment, the anti-theft device includes a lens ring assembly comprising a ring configured to removably engage a removable camera lens. The anti-theft device also includes a sensor cable assembly configured to attach to the lens ring assembly and to provide a signal indicative of an unauthorized removal of the lens ring assembly from the removable camera lens or removal of the sensor cable assembly from the lens ring assembly.

In some embodiments, the lens ring assembly comprises a threaded surface configured to threadably engage an end of the removable camera lens. The lens ring assembly may further comprise a transparent window disposed within the ring. In one example, the ring is annular in shape. According to one aspect, the lens ring assembly further comprises a cable attachment defining an opening configured to receive the sensor cable assembly for removably attaching the sensor cable assembly to the lens ring assembly. The cable attachment may be movably mounted within the lens ring. The sensor cable assembly may include a sensor switch configured to extend through the opening for engaging the removable lens. For example, the sensor switch may be a plunger configured to engage the removable camera lens. The sensor switch may be electrically connected to one end of a cable, while a connector may be electrically connected to an end of the cable opposite the sensor switch.

According to another embodiment, a system for protecting a removable camera lens from theft is provided. The system may include an anti-theft device as described above along with a camera comprising a removable camera lens. In some aspects, the lens ring assembly comprises a threaded external surface configured to threadably engage internal threads defined at an end of the removable camera lens. In some embodiments, the system also includes a sensor body configured to operably engage the sensor cable assembly and to be mounted to the camera. The sensor body may be configured to be removably supported on a display stand. The sensor cable assembly may include a connector electrically connected to an end of a cable that is configured to electrically connect the sensor cable assembly to the sensor body. In one aspect, the removable camera lens includes a free end configured to be removably engaged by the ring and an opposite end configured to removably attach to the camera.

According to one embodiment, a method for protecting a removable camera lens from theft is also provided. The method may include attaching a sensor cable assembly to a lens ring assembly and removably engaging the lens ring assembly to a removable camera lens (e.g., threading the lens ring assembly on a free end of the removable camera lens). The method may further include mounting a sensor body operably engaged with the sensor cable assembly to a camera comprising the removable camera lens. The sensor cable assembly may be configured to provide a signal to the sensor body indicative of unauthorized removal of the lens ring assembly from the removable camera lens or removal of the sensor cable assembly from the lens ring assembly.

### BRIEF DESCRIPTION OF THE DRAWINGS

FIG. 1 is a left-hand front perspective view of an anti-theft device according to one embodiment of the present invention.

FIG. 2 is a right-hand front perspective view of the anti-theft device of FIG. 1.

FIG. 3 is a top plan view of the anti-theft device of FIG. 1.

FIG. 4 is a side elevation view of the anti-theft device of FIG. 1.

FIG. 5 is a rear end view of the anti-theft device of FIG. 1.

FIG. 6 is a front end view of the anti-theft device of FIG. 1

FIG. 7 is an exploded perspective view of the anti-theft device of FIG. 1 showing the cable and the sensor switch detached from the lens ring.

FIG. 8 is a perspective view of an anti-theft device operably engaged with a camera having a removable camera lens according to one embodiment of the present invention.

### DETAILED DESCRIPTION

Embodiments of the present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation and multiple prime notations are used to indicate similar elements in alternative embodiments.

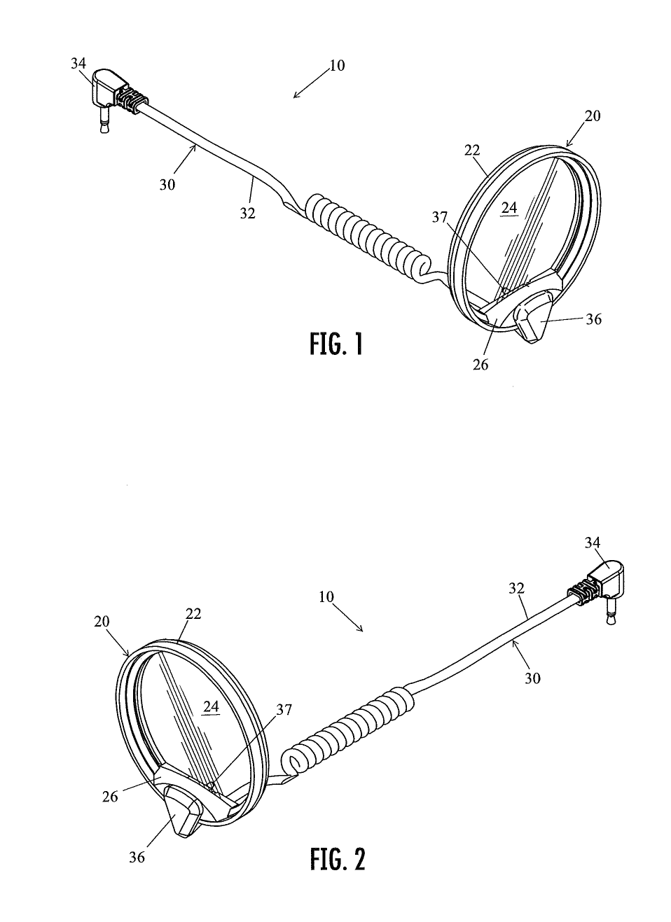

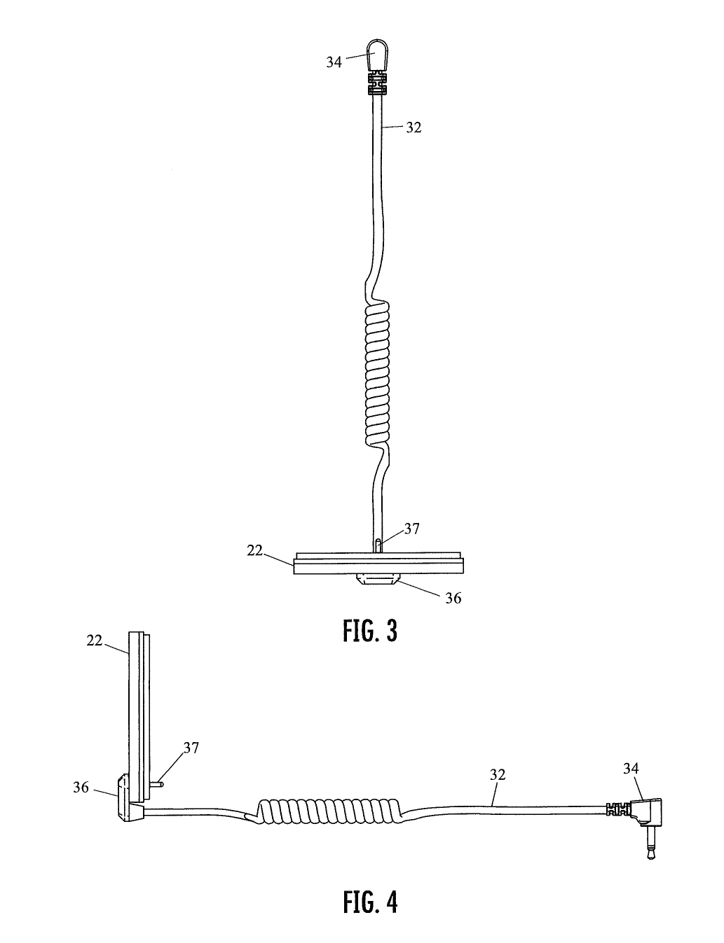

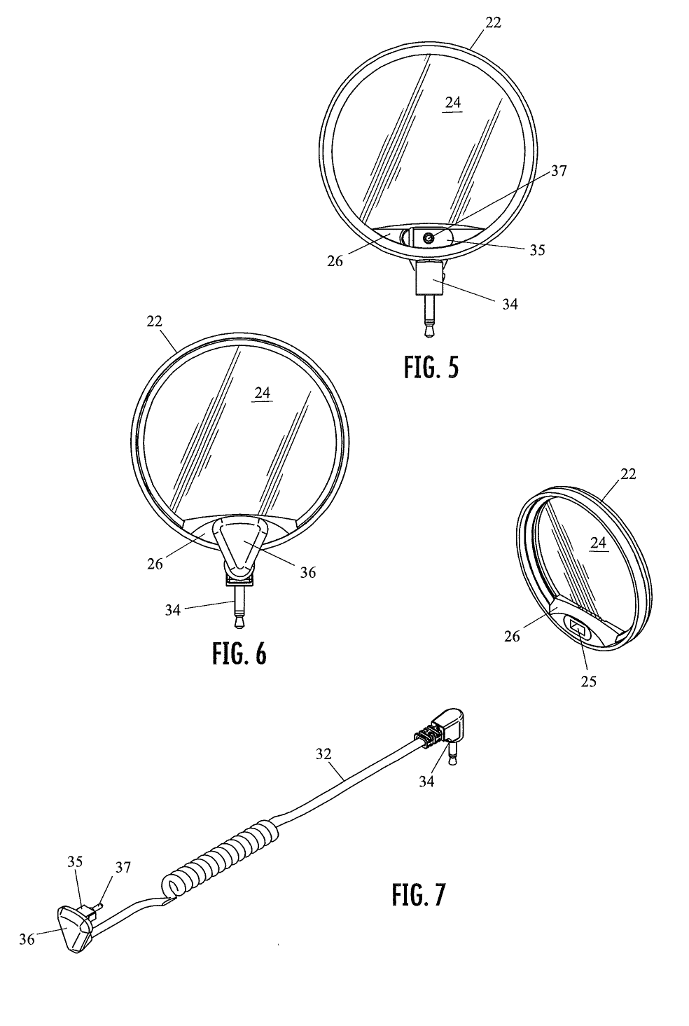

An embodiment of an anti-theft device 10 for a camera lens configured in accordance with the present invention is shown in FIGS. 1-7. FIG. 8 shows an embodiment of a system where an anti-theft device is operably engaged with a camera having a removable camera lens. Thus, the anti-theft device 10 is useable for protecting a camera lens from theft in a retail display of a camera 12 having a removable camera lens 13. The camera 12 is mounted to a main sensor body 14, also commonly referred to as a “sensor head,” that is removably supported on a merchandise security device, such as a display stand 16 secured to a table, counter, shelf or the like in a display area of a retail store. The camera has a removable camera lens 13 that is susceptible to theft separate and apart from the camera. As such, a potential shoplifter or thief may attempt to steal the camera lens with or without the camera.

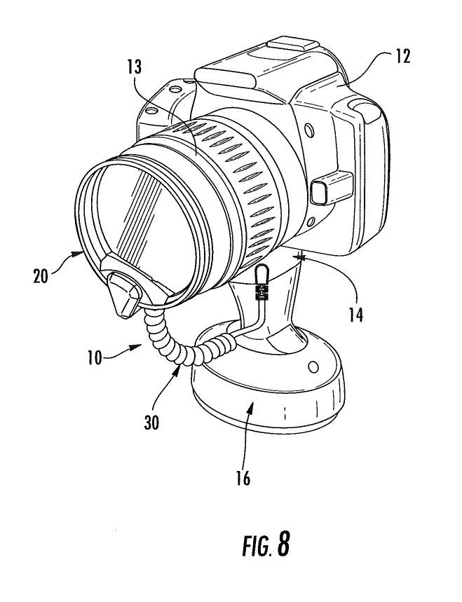

In one embodiment, the anti-theft device 10 comprises a lens ring assembly 20 and a sensor cable assembly 30 for mechanically and electrically coupling the lens ring assembly to the sensor head of the display stand. The lens ring assembly 20 may comprise a generally cylindrical, annular ring 22. Ring 22 may have external threads for engaging corresponding internal threads provided on the camera lens so that the lens ring may be threaded onto the free end of the camera lens. The camera may likewise be provided with internal threads for receiving corresponding external threads on the camera lens so that the camera lens may be removably attached to the camera. The open center of the ring 22 may be closed with a generally circular window 24 made of a transparent material, such as clear plastic or glass. Window 24 may be transparent so that a potential purchaser is able to examine the interior of the camera lens. Lens ring assembly 20 may further comprise a cable attachment 26 that defines an opening 25 (FIG. 7) therethrough configured (i.e. sized and shaped) for receiving a housing of a sensor switch at one end of the sensor cable assembly 30, as will be described. If desired, window 24 and cable attachment 26 may be movably mounted within ring 22 so that the sensor cable assembly 30 may be positioned on the ring such that the sensor cable assembly is conveniently located relative to the sensor head of the display stand.

In some embodiments, the sensor cable assembly 30 comprises a sensor cable 32, a connector 34 provided at one end of the sensor cable, and a sensor switch 36 provided at the other end of the sensor cable. The sensor cable 32 may comprise at least one, and sometimes at least a pair, of conductors encased within a protective sheath in a conventional manner. The sensor cable 32 may be a flat (e.g., straight) cable, or alternatively, at least a portion of the sensor cable may be a helical coiled cable, such as a conventional telephone cord, so that the overall length of the sensor cable may be extended as necessary. Regardless, connector 34 may be electrically connected to the conductors of the sensor cable 32 and configured to electrically connect the sensor cable assembly 30 to the sensor head of the display stand. Sensor switch 36 may likewise be electrically connected to the conductors of the sensor cable 32 and configured to mechanically attach the sensor cable assembly 30 to the cable attachment 26 of the lens ring assembly 20.

In one embodiment, the sensor switch 36 comprises a housing 35 having a reduced portion configured (sized and shaped) to be received within the opening 25 defined by the cable attachment 26 of the lens ring assembly 20. It will be readily appreciated by those skilled in the art that the cable attachment 26 may permit the same sensor cable assembly 30 to be utilized with a lens ring assembly 20 having a different outer diameter configured for use with a camera lens having a different diameter. The sensor switch 36 may comprise any sensor technology suitable for providing an electrical signal to the sensor head of the display stand indicating whether the anti-theft device 10 is properly attached to the camera lens. In the embodiment shown and described herein, the sensor switch 36 is a conventional limit switch, commonly referred to as a “plunger switch,” having an outwardly biased plunger 37 configured to engage a structural feature (e.g. rim) of the camera lens when the housing 35 of the sensor switch is properly positioned within the opening 25 of the cable attachment 26 of the lens ring assembly 20. If desired, the reduced portion of the housing 35 may be provided with a retaining clip (not shown) for releasably attaching the housing of the sensor switch 36 to the cable attachment 26 of the lens ring assembly 20. It should be noted that the retaining clip may be accessible only from the interior side of the cable attachment 26 (i.e. from within the camera lens) when the lens ring assembly 20 and the sensor cable assembly 30 are installed on the camera lens, as will be described. As such, the retaining clip cannot be accessed to detach the sensor cable assembly 30 from the lens ring assembly 20 without disengaging the plunger 37 of the sensor switch 36 from the camera lens.

Once the lens ring assembly 20 is properly positioned and threaded onto the camera lens, the reduced portion of the housing 35 of the sensor switch 36 may be inserted through the opening 25 of the cable attachment 26 until the retaining clip (if provided) securely attaches the sensor switch to the cable attachment. With the sensor switch 36 properly attached to the cable attachment 26, the plunger 37 may be depressed by a structural feature of the camera lens to indicate a “secured” state of the sensor switch. The connector 34 of the sensor cable assembly 30 is then electrically connected to the sensor head of the display stand in a known manner such that the anti-theft device is operationally coupled to the monitoring electronics of the sensor head. In the event that the outwardly biased plunger 37 moves from the depressed position to an extended position to indicate an “unsecured” state of the sensor switch 36, the monitoring electronics of the sensor head may activate an alarm to alert store personnel to a possible theft condition. For example, the plunger 37 may move from the depressed position to the extended position if the housing 35 of the sensor switch is detached and removed from the opening 25 of the cable attachment 26. Similarly, the plunger 37 may “open” if the ring 22 of the lens ring assembly 20 is rotated in a direction that unthreads (i.e. decouples) the lens ring assembly from the camera lens. In either event, the monitoring electronics of the sensor head may activate an audible and/or visible alarm to alert store personnel to the possible theft attempt.

Many modifications and other embodiments of the invention will be readily apparent to one skilled in the art having the benefit of the teachings presented in the foregoing descriptions and the associated drawings. Therefore, it is understood and appreciated that the invention is not to be limited to the specific embodiments disclosed herein, and that modifications to the disclosed embodiments and other undisclosed embodiments are intended to be included within the scope of the appended claims.

That which is claimed is:

1. An anti-theft device for protecting a removable camera lens from theft, the anti-theft device comprising:
a lens ring assembly comprising a ring configured to removably engage a removable camera lens; and
a sensor cable assembly configured to attach to the lens ring assembly and to provide a signal indicative of an unauthorized removal of the lens ring assembly from the removable camera lens or removal of the sensor cable assembly from the lens ring assembly.

2. The anti-theft device of claim 1, wherein the lens ring assembly comprises a threaded surface configured to threadably engage an end of the removable camera lens.

3. The anti-theft device of claim 1, wherein the lens ring assembly further comprises a transparent window disposed within the ring.

4. The anti-theft device of claim 1, wherein the lens ring assembly further comprises a cable attachment defining an opening configured to receive the sensor cable assembly for removably attaching the sensor cable assembly to the lens ring assembly.

5. The anti-theft device of claim 4, wherein the cable attachment is movably mounted within the lens ring.

6. The anti-theft device of claim 4, wherein the sensor cable assembly comprises a sensor switch configured to extend through the opening for engaging the removable lens.

7. The anti-theft device of claim 6, wherein the sensor switch comprises a plunger configured to engage the removable camera lens.

8. The anti-theft device of claim 1, wherein the sensor cable assembly comprises a sensor switch electrically connected to one end of a cable.

9. The anti-theft device of claim 8, wherein the sensor cable assembly further comprises a connector electrically connected to an end of the cable opposite the sensor switch.

10. The anti-theft device of claim 1, wherein the ring is annular in shape.

11. A system for protecting a removable camera lens from theft, the system comprising:
a camera comprising a removable camera lens;
a lens ring assembly comprising a ring configured to removably engage the removable camera lens; and
a sensor cable assembly configured to attach to the lens ring assembly and to provide a signal indicative of unauthorized removal of the lens ring assembly from the removable camera lens or removal of the sensor cable assembly from the lens ring assembly.

12. The system of claim 11, wherein the lens ring assembly comprises a threaded external surface configured to threadably engage internal threads defined at an end of the removable camera lens.

13. The system of claim 11, further comprising a sensor body configured to operably engage the sensor cable assembly and to be mounted to the camera.

14. The system of claim 13, wherein the sensor cable assembly comprises a connector electrically connected to an end of a cable that is configured to electrically connect the sensor cable assembly to the sensor body.

15. The system of claim 14, wherein the sensor cable assembly further comprises a sensor switch electrically connected to an end of the cable opposite the connector.

16. The system of claim 11, wherein the lens ring assembly further comprises a cable attachment defining an opening configured to receive the sensor cable assembly for removably attaching the sensor cable assembly to the lens ring assembly.

17. The system of claim 16, wherein the sensor cable assembly comprises a sensor switch configured to extend through the opening for engaging the removable lens.

18. The system of claim 17, wherein the sensor switch comprises a plunger configured to engage the removable camera lens.

19. The system of claim 11, wherein the removable camera lens comprises a free end configured to be removably engaged by the ring and an opposite end configured to removably attach to the camera.

20. A method for protecting a removable camera lens from theft, the method comprising:
attaching a sensor cable assembly to a lens ring assembly;
removably engaging the lens ring assembly to a removable camera lens; and
mounting a sensor body operably engaged with the sensor cable assembly to a camera comprising the removable camera lens, wherein the sensor cable assembly is configured to provide a signal to the sensor body indicative of unauthorized removal of the lens ring assembly from the removable camera lens or removal of the sensor cable assembly from the lens ring assembly.
